(19) United States
(12) Patent Application Publication
(10) Pub. No.: US 2026/0135026 A1
(43) Pub. Date: May 14, 2026

(54) N-PHASE TLVR INTEGRATED INDUCTOR, AND TLVR MODULE AND VERTICAL POWER SUPPLY SYSTEM

(71) Applicant: MetaPWR Electronics Co., Ltd., Shanghai (CN)

(72) Inventors: Mingzhun ZHANG, Shanghai (CN); Xiaoni Xin, Shanghai (CN); Yahong Xiong, Shanghai (CN)

(73) Assignee: MetaPWR Electronics Co., Ltd., Shanghai (CN)

(21) Appl. No.: 19/389,032

(22) Filed: Nov. 14, 2025

(30) Foreign Application Priority Data
Nov. 14, 2024 (CN) 202411627853.8

(51) Int. Cl. H01F 27/28; H01F 27/02; H01F 27/24; H01F 27/40

(52) U.S. Cl. CPC H01F 27/28; H01F 27/02; H01F 27/24; H01F 27/40

(57) ABSTRACT

The application discloses an N-phase TLVR integrated inductor, utilizes a main winding and an auxiliary winding with the same structure. Winding pins are arranged on the lower surface of the magnetic core, and coupling achieves a smaller dynamic inductance. An N-phase TLVR module is also provided, wherein a vertical switch device is embedded in a substrate of a bottom assembly. The integrated inductor and capacitor are disposed on the substrate's upper surface, and the inductor connects to the switch via wiring in the substrate. The substrate's lower surface, including an associated capacitor and metal column, is molded into a plastic package. A surface metal wiring layer on the package's lower surface connects to external components. This construction reduces module volume and improves dynamic performance.

### CROSS-REFERENCE TO RELATED APPLICATIONS

This application claims the priority benefit of Chinese application serial no. 202411627853.8, filed on Nov. 14, 2024. The entirety of the above-mentioned patent application is hereby incorporated by reference herein and made a part of this specification.

### BACKGROUND

In recent years, with the development of technologies such as data center, artificial intelligence, and supercomputers, more and more powerful ASICs are being applied, such as CPU, GPU, TPU, NPU, ML, AI accelerator, network switch, server, etc. and they consume a large amount of current, such as thousands of amperes, and the demand for power greatly and quickly. A multi-phase voltage regulator (VRM-Voltage Regulator Module) is conventionally used to supply such a load. To keep up with an increase in load current and bandwidth, the existing solution is to increase the number of phases of the voltage regulator and increase the capacitance of the output decoupling capacitor. These approaches improve the transient response of a conventional VR; however, due to factors such as the large output impedance of the load, a high volume requirement of the decoupling capacitor and the distance between the decoupling capacitor and the load, so that the traditional VR achieves a performance limit in transient response. On the other hand, transient responses are often improved by improving other techniques of conventional VR, such as increasing switching frequency and/or decreasing inductance value, but at the expense of reduced efficiency.

The anti-coupling inductance technology has a relatively low leakage inductance, and therefore has a relatively fast transient response. In addition, the anti-coupling inductor has a relatively high steady-state equivalent inductance, which is beneficial to the improvement of efficiency. That is, the anti-coupling inductance technology can meet the requirements of transient performance, and can also improve the efficiency. Therefore, the anti-coupling technology is a hotspot of a VR design. In addition, the Trans-inductor voltage regulator (hereinafter referred to as TLVR) technology can achieve coupling of multiple mutually independent inductors that have no coupling relationship with each other by means of the auxiliary winding; the performance of multi-phase coupling inductor can also be achieved; therefore, the Trans-inductor voltage regulator is also a design hotspot in the field. Regarding to the dynamic performance and steady-state efficiency of the output voltage of the VR module, the present application provides a low-dynamic-sensing TLVR and an anti-coupling solution.

### SUMMARY

In view of the above, one of the objectives of the application is to provide an N-phase TLVR integrated inductor, comprising a magnetic core and N winding assemblies, wherein N is an even number greater than or equal to 4; the magnetic core comprises an upper surface, a lower surface, a first side surface, a second side surface, a third side surface and a fourth side surface; the magnetic core is provided with at least N windows, and the window penetrates through the upper surface and the lower surface of the magnetic core;

The winding assembly comprises a main winding, an auxiliary winding and an insulating component, wherein the insulating component is arranged between the main winding and the auxiliary winding; the main winding and the auxiliary winding are coupled; the winding assembly is at least partially arranged in the window; and pins are formed on a part of the surface of the main winding and the auxiliary winding exposed on the lower surface of the magnetic core.

Preferably, the main winding, the auxiliary winding, and the insulating component are horizontally arranged or vertically stacked.

Preferably, at least a part of the main winding is exposed on the upper surface of the magnetic core.

Preferably, the shape of the main winding is the same as the shape of the auxiliary winding.

Preferably, the shape of the main winding and the auxiliary winding is in “Π” shape, and comprises a horizontal portion and two vertical portions; the two vertical portions are disposed in two windows respectively; the upper surface of the horizontal portion is flush with the upper surface of the magnetic; the lower surface of the two vertical portions is formed to pin protrusions.

Preferably, the two winding assembly protrude three windows; two adjacent vertical portions of the two winding assemblies share one window; each of two non-adjacent vertical portions of the two winding assemblies protrudes one windows respectively.

Preferably, the magnetic core comprises at least N hole grooves.

Preferably, the shape of the main winding and the auxiliary winding is in “Π” shape, and comprises a horizontal portion and two vertical portions; the two vertical portions are disposed in one window and one hole groove respectively; the upper surface of the horizontal portion is flush with the upper surface of the magnetic; the lower surface of the two vertical portions is formed to pin protrusions.

Preferably, a part of the vertical portion of each winding assembly disposed in the hole groove is exposed on the side surface of the magnetic core.

Preferably, the main windings and the auxiliary windings of two winding assemblies share one insulating component; the two main windings are arranged at one side of the insulating component, and the two auxiliary windings are arranged at the other side of the insulating component.

Preferably, the winding assembly is integrally formed by a plastic packaging process; or the main winding, the auxiliary winding and the insulating component in each winding assembly are assembled together.

Preferably, the winding assembly protrudes from the lower surface of the magnetic core to form a pin protrusion, and a height of the pin protrusion is greater than or equal to 0.7 mm.

Preferably, a height between the pin and the lower surface of the magnetic core is between 0 and 0.2 mm.

Preferably, wherein the magnetic core comprises a first magnetic core, a second magnetic core and a third magnetic core; the third magnetic core is arranged between the first magnetic core and the second magnetic core; the winding assemblies are arranged between the first magnetic core and the third magnetic core, and between the second magnetic core and the third magnetic core.

Preferably, the first magnetic core and part of the main windings are integrally pressed to form a first magnetic assembly; the second magnetic core and the other part of the main windings are integrally pressed to form a second magnetic assembly; the third magnetic core and the auxiliary winding are integrally pressed to form a third magnetic assembly; the first magnetic assembly, the second magnetic assembly and the third magnetic assembly are assembled by means of the insulating component.

An N-phase TLVR module, comprising an N-phase TLVR integrated inductor and a bottom assembly; the bottom assembly comprises a substrate and a switching device; the bottom assembly comprises an upper surface and a lower surface opposite to each other; the N-phase TLVR module is arranged on the upper surface of the bottom assembly; one pin of each main winding is electronically connected with the switching device; a output positive connection portion is disposed on the lower surface of the substrate; the other pin of each main winding is electronically connected with the output positive connection portion.

Preferably, the bottom assembly further comprises a capacitor and a metal column; the substrate comprises an upper surface and a lower surface opposite to each other; the capacitor is arranged on the substrate; the switching device is embedded in the substrate; one pin of each main winding is electrically connected to the switching device by means of the substrate, and the other pin of each main winding is electrically connected to the capacitor by means of the substrate; and the metal columns are provided on the upper surface and/or the lower surface of the substrate.

Preferably, a SW pad and an output positive pad are disposed on the upper surface of the bottom assembly; an input positive connection portion and a ground connection portion are disposed on the lower surface of the bottom assembly; one pin of each main winding is fixed and electronically connected with the SW pad, the other pin of each main winding is fixed and electronically connected with the output positive pad; the switching device is a vertical device; the switching device comprises a first switching device and a second switching device; a drain electrode of the first switching device and a source electrode of the second switching device face the lower surface of the substrate, the drain electrode of the first switching device is electronically connected with the input positive connection portion, the source electrode of the second switching device is electronically connected with the ground connection portion; a source electrode of the first switching device and a drain electrode of the second switching device face the upper surface of the substrate, and are both electronically connected to the SW pad; the output positive pad and the output positive connection portion are electrically connected.

Preferably, the drain electrode of the first switching device is electronically connected to the input positive connection portion by means of the metal column; the source electrode of the second switching device is electronically connected to the ground connection portion by means of the metal column; the source electrode of the first switching device and the drain electrode of the second switching device are electronically connected by means of the metal column or a redistribution layer. Preferably, the capacitor comprises an input capacitor and/or an output capacitor; the input capacitor is disposed on the upper surface of the substrate, and two ends of the input capacitor are electronically connected to the input positive connection portion and the ground connection portion respectively; the output capacitor is disposed on the lower surface of the substrate, and two ends of the output capacitor are electronically connected to the output positive connection portion and the ground connection portion respectively.

Preferably, the pin is flush with the lower surface of the magnetic core, and the winding assembly and the substrate are electrically connected through the metal column.

Preferably, a part of the metal columns are used for electrically connecting the auxiliary winding and the substrate, and are used for realizing the electrical connection of the auxiliary winding loop.

Preferably, the upper surface of the substrate and the metal column and the capacitor disposed on the upper surface are molded together to form an upper surface plastic package, and the upper surface of the upper surface plastic package is provided with a pad.

Preferably, a part of the pads is configured to electrically connect the auxiliary winding.

Preferably, the lower surface of the substrate and the metal column and the capacitor disposed on the lower surface are molded together to form a lower surface plastic package, and the lower surface of the lower surface plastic package is provided with the connection portions.

Preferably, the auxiliary winding is electrically connected through the substrate; auxiliary winding pads are disposed on the upper surface of the bottom assembly, the auxiliary winding pads are fixed with and electronically connected to two ends of the auxiliary winding; a extension connection portion is disposed on the lower surface of the bottom assembly, and the extension connection portion is used for electronically connecting the auxiliary winding between at least two N-phase TLVR modules.

An XPU vertical power supply system includes an adapter substrate, a controller, and M N-phase TLVR modules; the adapter substrate includes an upper surface and a lower surface opposite to each other, the M N-phase TLVR modules are disposed on the upper surface of the adapter substrate, and the lower surface of the adapter substrate is configured to electrically connect to an external assembly.

The XPU vertical power supply system of claim 18, wherein the M N-phase TLVR modules and the controller are uniformly distributed on the upper surface of the adapter substrate.

Compared with the prior art, the application has the following beneficial effects:
(1) The present application provides an N-phase TLVR integrated inductor, N being an even number greater than or equal to 4, and using a main winding and an auxiliary winding having the same structure, and arranging the pins of the winding on the lower surface of the magnetic core, and realizing a smaller dynamic inductance by means of the coupling between the main winding and the auxiliary winding.
(2) In another aspect, the present application provides an N-phase TLVR module, wherein a vertical switch device is embedded in a substrate of a bottom assembly, the TLVR integrated inductor and the capacitor are arranged on an upper surface of the bottom assembly, and the TLVR integrated inductor is electrically connected to the vertical switch device by means of a wiring in the substrate; the lower surface of the substrate and the capacitor and the metal column provided on the lower surface are molded to form a plastic package, and the surface metal wiring layer is provided on the lower surface of the plastic package to be electrically connected to the external component, thereby further reducing the volume of the module and improving the dynamic performance of the module.

### BRIEF DESCRIPTION OF THE DRAWINGS

FIG. 1 is a circuit schematic diagram of a TLVR voltage regulator;

FIGS. 2A-2D are an embodiment of a TLVR module;

FIG. 3A to FIG. 3C are another embodiment of an integrated inductor;

FIG. 4A and FIG. 4B are another embodiment of an integrated inductor;

FIG. 5A to FIG. 5C are another embodiment of an integrated inductor;

FIGS. 6A-6D are another embodiment of a TLVR module;

FIGS. 7A and 7B are another embodiment of a bottom assembly;

FIGS. 8A and 8B are another embodiment of a bottom assembly;

FIG. 9 is an application embodiment of a TLVR module.

### DESCRIPTION OF THE EMBODIMENTS

One of the cores of the present application is to provide an N-phase TLVR integrated inductor, N being an even number greater than or equal to 4, a main winding and an auxiliary winding having the same structure are used, the pins of the winding are arranged on the lower surface of the magnetic core, and a smaller dynamic inductance is achieved by means of the coupling between the main winding and the auxiliary winding; in another aspect, the present application provides an N-phase TLVR module. By embedding a vertical switch device in a substrate of a bottom assembly, a TLVR integrated inductor and a capacitor are arranged on an upper surface of the bottom assembly, and the TLVR integrated inductor is electrically connected to the vertical switch device by means of a wiring in the substrate; the lower surface of the substrate and the capacitor and the metal column provided on the lower surface are molded to form a plastic package, and the surface metal wiring layer is provided on the lower surface of the plastic package to be electrically connected to the external component, thereby further reducing the volume of the module and improving the dynamic performance of the module. The external component herein may be a load.

Technical solutions in the embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

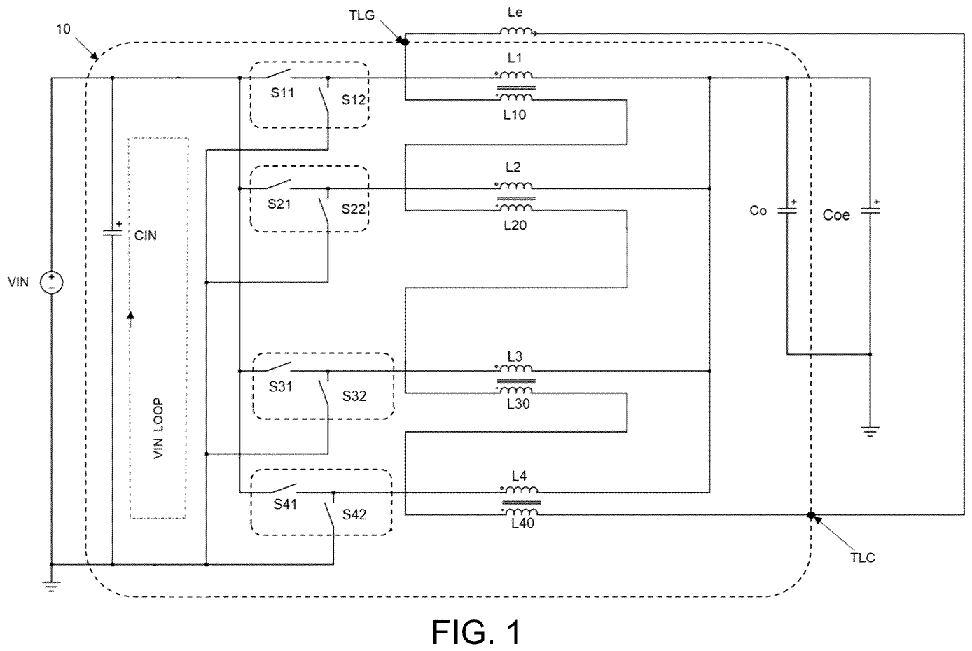

FIG. 1 is a circuit schematic diagram of a voltage regulator using a Trans-inductor voltage regulator (hereinafter referred to as TLVR) technology, wherein the voltage regulator comprises four phases of Buck circuit electrically connected in parallel, each phase of Buck circuit comprises an output inductor, and the four output inductors are originally four mutually independent inductors, that is, there is no magnetic coupling between the four main windings L1, L2, L3, and L4. The voltage regulator further comprises four auxiliary windings L10, L20, L30 and L40. The four auxiliary windings are respectively magnetically coupled to one of the four main windings L1, L2, L3 and L4; that is, the main winding L1 and the auxiliary winding L10 are magnetically coupled; the main winding L2 and the auxiliary winding L20 are magnetically coupled; the main winding L3 and the auxiliary winding L30 are magnetically coupled; and the main winding L4 and the auxiliary winding L40 are magnetically coupled. The auxiliary windings L10, L20, L30 and L40 are sequentially connected end-to-end to form an auxiliary loop, so that there is an anti-coupling relationship between any two of the four main windings L1, L2, L3 and L4; or alternatively, an external compensation inductor Le is added to the auxiliary loop, and also has the technical features of anti-coupling. Here, the number of phases of the parallel Buck circuit is not limited to 4 phases, as long as a TLVR module greater than or equal to two phases can obtain the same technical effect. A voltage regulator (hereinafter referred to as a TLVR module) using a TLVR inductor, as shown in FIG. 1, the four-phase TLVR module adopts four control signals, and the phase shift between two adjacent phases is 360degrees/4, i.e. 90 degrees. When the TLVR module adopts a N-phase Buck circuit to be connected in parallel (N is a natural number greater than 1), the phase shift between two adjacent phases is 360 degrees/N.

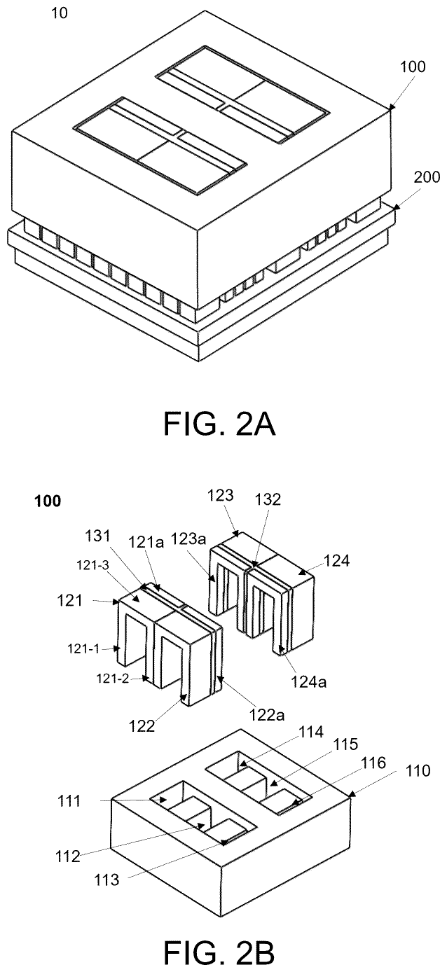

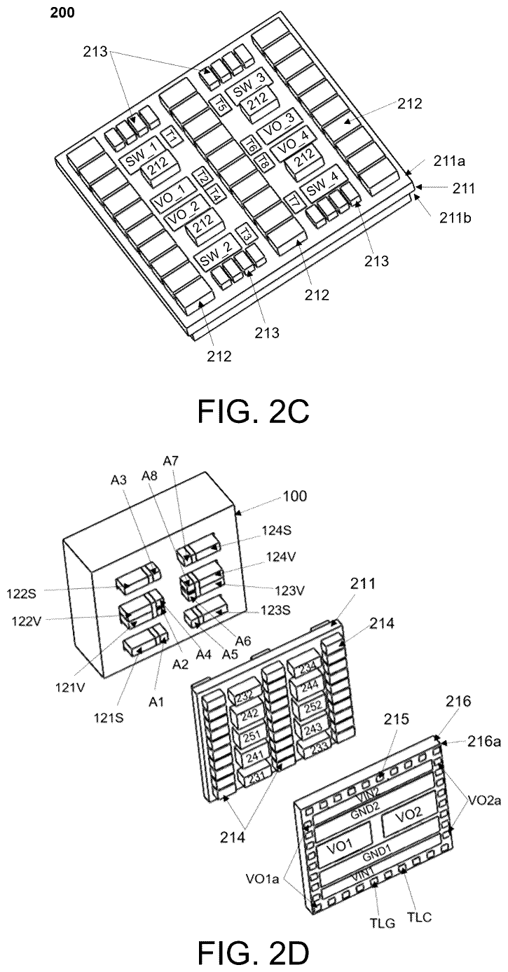

FIG. 2A to FIG. 2D are an embodiment of a TLVR module, wherein FIG. 2A is a schematic structural diagram of the TLVR module, and the TLVR module 10 includes an integrated inductor 100 and a bottom assembly 200; and FIG. 2B is a structural exploded view of the integrated inductor 100; FIG. 2C is a schematic structural diagram of the bottom assembly 200, and FIG. 2D is an exploded schematic diagram of the TLVR module shown in FIG. 2A.

As shown in FIG. 2B, the integrated inductor 100 comprises a magnetic core 110 and four winding assemblies, each winding assembly comprising a main winding, an auxiliary winding and an insulating component; the main winding and the auxiliary winding have the same shape; the insulating component is arranged between the main winding and the auxiliary winding, and the main winding and the auxiliary winding are arranged together according to the shape. The magnetic core 110 comprises an upper surface and a lower surface opposite to each other, six windows 111, 112, 113, 114, 115 and 116 penetrating through the upper and lower surfaces of the magnetic core 110. In detail, the first winding assembly comprises a first main winding 121, a first auxiliary winding 121a and a first insulating component 131; the first winding assembly passes through the windows 111 and 112. The second winding assembly comprises a second main winding 122, a second auxiliary winding 122a and a first insulating component 131; the second winding assembly passes through the windows 112 and 113. The third winding assembly comprises a third main winding 123, a third auxiliary winding 123a and a second insulating component 132; the third winding assembly passes through the windows 114 and 115. The fourth winding assembly comprises a fourth main winding 124, a fourth auxiliary winding 124a and a second insulating component 132; the fourth winding assembly passes through the windows 115 and 116.

Each of the main windings and each auxiliary winding are of a “Π” shape. Taking the first main winding 121 as an example, the first main winding 121 comprises two vertical portions 121-1, 121-2 and a horizontal portion 121-3. The two vertical portions 121-1 and 121-2 pass through the windows 111 and 112, respectively, such that the upper surface of the horizontal portion 121-3 is exposed on the upper surface of the magnetic core 110, and the lower surface of the two vertical portions 121-1 and 121-2 is exposed on the lower surface of the magnetic core 110. After the first main winding 121 and the magnetic core 110 are assembled, the upper surface of the horizontal portion 121-3 is flush with the upper surface of the magnetic core 110 or slightly lower than the upper surface of the magnetic core 110; the lower surface of the vertical portions 121-1 and 121-2 protrude from the lower surface of the magnetic core 110 to form a pin protrusion, wherein the height of the pin protrusion is greater than or equal to 0.7 mm. The shapes and settings of the other main windings and the other auxiliary windings can be referred to the first winding assembly, which will not be repeated here. A lower surface of the first winding assembly exposed from the window 111 are pins 121S and A1, and a lower surface of the first winding assembly exposed from the window 112 are pins 121V and A2, wherein the pins 121S and 121V are the lower surfaces of the first main winding 121, and pins A1 and A2 are the lower surfaces of the first auxiliary winding 121a. A lower surface of the second winding assembly exposed from the window 113 are pins 122S and A3, and a lower surface of the second winding assembly exposed from the window 112 are pins 122V and A4, wherein the pins 122S and 122V are the lower surfaces of the second main winding 122, and pins A3 and A4 are the lower surfaces of the second auxiliary winding 122a. A lower surface of the third winding assembly exposed from the window 114 are pins 123S and A5, and a lower surface of the third winding assembly exposed from the window 115 are pins 123V and A6, wherein the pins 123S and 123V are the lower surfaces of the third main winding 123, and pins A5 and A6 are the lower surfaces of the third auxiliary winding 123a. A lower surface of the fourth winding assembly exposed from the window 116 are pins 124S and A7, and a lower surface exposed from the window 115 are pins 124V and A8, wherein the pins 124 S and 124V are the lower surfaces of the fourth main winding 124, and pins A7 and A8 are the lower surfaces of the fourth auxiliary winding 124a. The vertical portions of the first auxiliary winding 121a and the second auxiliary winding 122a within the window 112 require electrical isolation, and the vertical portions of the third auxiliary winding 123a and the fourth auxiliary winding 124a within the window 115 require electrical isolation. The vertical portions of the first and second main windings 121, 122 within the window 112 may be electrically isolated or directly electrically connected together; the vertical portions of the third and fourth main windings 123, 124 within the window 115 may be electrically isolated or directly electrically connected together. Each winding assembly may be a main winding, an auxiliary winding, and an insulating component assembled together; or the main winding, the auxiliary winding, and the insulating component can also be integrally laminated, thereby simplifying the mounting step. Each winding assembly and the magnetic core 110 can be assembled and adhered the winding assembly to the window of the magnetic core by using glue, or the winding assembly and the magnetic core can be integrally laminated.

Referring to FIGS. 2C and 2D, the bottom assembly 200 includes a substrate 211, an input capacitor 212, other passive elements 213, an output capacitor 214, a plastic package 216, and metal columns 231-234, 241-244 and 251-252. The substrate 211 comprises an upper surface 211a and a lower surface 211b opposite to each other. The input capacitor 212 and other passive elements 213 are provided on the upper surface 211a of the substrate 211; the upper surface 211a of the substrate is further provided with SW pads SW_1, SW_2, SW_3 and SW_4 and output positive pads Vo_1, Vo_2, Vo_3 and Vo_4 and auxiliary winding pads T1-T8. Preferably, the output positive pads Vo_1 and Vo_2 are electrically connected together, and the output positive pads Vo_3 and Vo_4 are electrically connected together; the auxiliary winding pads T2 and T4 are electrically isolated, and the auxiliary winding pads T6 and T8 are electrically isolated. When the integrated inductor 100 is assembled with the bottom assembly 200, the pins 121S, 121V, A1 and A2 of the first winding assembly are fixed and electrically connected to the pads SW_1, Vo_1, T1 and T2 in sequence; pins 122S, 122V, A3 and A4 of the second winding assembly are fixed and electrically connected to the pads SW_2, Vo_2, T3 and T4 in sequence; pins 123S, 123V, A5 and A6 of the third winding assembly are fixed and electrically connected to the pads SW_3, Vo_3, T5 and T6 in sequence; pins 124S, 124V, A7 and A8 of the fourth winding assembly are fixed and electrically connected to the pads SW_4, Vo_4, T7 and T8 in sequence. In the present embodiment, the pins of the winding assembly protrude from the lower surface of the magnetic core to form a pin protrusion, and an accommodating space between the lower surface of the magnetic core and the upper surface of the substrate is used for accommodating an input capacitor or other passive components; the height of the corresponding input capacitor or the height of other passive elements should be lower than the height of the pin protrusion of the winding assembly.

The output capacitor 214 and the metal columns 231-234, 241-244, 251-252 are disposed on the lower surface 211b of the substrate, and the plastic encapsulant encapsulates the lower surface 211b and the output capacitor and the metal column. Further, the outer surface 216a of the plastic package 216 is provided with pins by means of metallization, and the pins may be input positive connection portions VIN1 and VIN2, ground connection portions GND1 and GND2, output positive connection portions VO1 and VO2, signal connection portions (not shown), and extension connection portions TLG and TLC (not shown). Wherein the input positive connection portion, the ground connection portion and the output positive connection portion can be formed by means of polishing the outer surface 216a of the plastic package to exposing the surfaces of the metal columns 231-234, 241-244 and 251-252 and then electroplating to form connection portions with a larger area; and the connection portion can also be electrically connected to the corresponding metal column by means of drilling and electroplating, and a large-area connection part is further electroplated on the outer surface of the plastic package. The signal connection portion and the extension connection portion may be electrically connected to corresponding pads on the lower surface of the substrate by means of drilling, electroplating or half-hole electroplating, and the outer surface of the plastic package is further electroplated to form a corresponding large-area connection portion. The extension connection portion TLG and the TLC here are used when two or more four-phase TLVR modules are connected in parallel, and the series electrical connection between auxiliary windings between the multiple TLVR modules can be implemented.

The driving semiconductor switch device is embedded in the substrate 211 (not shown), that is, the switching devices S11, S12, S21, S22, S31, S32, S41 and S42 shown in FIG. 1 are embedded in the substrate 211. Preferably, these switching devices are vertical devices. The switching devices S11 and S12 in a phase Buck circuit are used as an example, both a drain electrode of the switching device S11 and a source electrode of the switching device S12 are provided toward the lower surface 211b of the substrate 211. The drain electrode of the switching device S11 is electrically connected to the input positive connection portion VIN1 of the outer surface 216a of the plastic package by means of the metal column 231, and the source electrode of the switching device S12 is electrically connected to the ground connection portion GND1 of the outer surface 216a of the plastic package by means of the metal column 241. A source electrode of the switching device S11 and a drain electrode of the switching device S12 are both arranged toward the upper surface 211a of the substrate 211, and are electrically connected to the SW pad SW_1 provided on the upper surface of the substrate by means of a redistribution layer (RDL), thereby forming a phase Buck circuit. A drain electrode of the switching device S21 and a source electrode of the switching device S22 are both arranged toward the lower surface 211b of the substrate 211; the drain electrode of the switching device S21 is electrically connected to the input positive connection portion VIN2 of the outer surface 216a of the plastic package by means of the metal column 232; and the source electrode of the switching device S22 is electrically connected to the ground connection portion GND2 of the outer surface 216a of the plastic package by means of the metal column 242. A source electrode of the switching device S21 and a drain electrode of the switching device S22 are both arranged toward the upper surface 211a of the substrate 211, and are electrically connected to the SW pad SW_2 provided on the upper surface of the substrate by means of a redistribution layer (RDL). A drain electrode of the switching device S31 and a source electrode of S32 are both arranged toward the lower surface 211b of the substrate 211, the drain electrode of the switching device S31 is electrically connected to the input positive connection portion VIN1 of the outer surface 216a of the plastic package by means of the metal column 233, and the source electrode of the switching device S32 is electrically connected to the ground connection portion GND1 of the outer surface 216a of the plastic package by means of the metal column 243. A source of the switching device S31 and a drain of the switching device S32 are both arranged toward the upper surface 211a of the substrate 211, and are electrically connected with the SW pad SW_3 provided on the upper surface of the substrate by means of a redistribution layer (RDL). A drain electrode of the switching device S41 and a source electrode of the switching device S42 are both arranged toward the lower surface 211b of the substrate 211, the drain electrode of the switching device S41 is electrically connected to the input positive connection portion VIN2 of the outer surface 216a of the plastic package by means of the metal column 234, and the source electrode of the switching device S42 is electrically connected to the ground connection portion GND2 of the outer surface 216a of the plastic package by means of the metal column 244. A source of the switching device S41 and a drain of the switching device S42 are both arranged toward the upper surface 211a of the substrate 211, and are electrically connected with the SW pad SW_4 provided on the upper surface of the substrate by means of a redistribution layer (RDL). Here, the electrical connection between the output positive connection portion VO1 and the VO2 is optimal. The connection mode of each phase Buck circuit as mentioned above can further reduce the direct current impedance on the power path and improve the conversion efficiency of the TLVR module. The main winding is electrically connected to the switching device by means of the RDL on the upper surface 211a of the substrate, and the upper surface of the horizontal portion of the main winding is exposed on the upper surface of the magnetic core, such that the structure facilitates the heat generated by the switching device to dissipate to the upper surface of the magnetic core by means of the winding; furthermore, the heat can dissipate by means of the heat sink (not shown) provided on the upper surface of the magnetic core.

As shown in FIG. 2D, a positive terminal of part of the output capacitors 214 is electrically connected to the output positive connection portion VO1a, a positive terminal of part of the output capacitors 214 is electrically connected to the output positive connection portion VO2a, and may also be electrically connected to the output positive connection portion VO1 and VO2; a negative terminal of the output capacitor 214 is electrically connected to the ground connection portion GND1 and the GND2 at a nearby location, respectively. The output capacitor 214 is used for storing energy, thereby improving the dynamic performance of the output voltage.

There are a plurality of connection manners of the auxiliary winding, and the first connection manner is that the extension connection portion TLG is electrically connected to the pin A1 of the first auxiliary winding by means of the substrate 211, the pin A2 of the first auxiliary winding is electrically connected to the pin A5 of the third auxiliary winding by means of the RDL in the substrate 211, the pin A6 of the third auxiliary winding is electrically connected to the second auxiliary winding A3 by means of the RDL in the substrate 211, the pin A4 of the second auxiliary winding is electrically connected to the pin A7 of the fourth auxiliary winding by means of the RDL in the substrate 211, and the pin A8 of the fourth auxiliary winding is electrically connected to the extended connection portion TLC by means of the RDL in the substrate 211. For simplicity, the above connection sequence may be expressed as: TLG→A1→A2→A5→A6→A3→A4→A7→A8→TLC. The second connection manner may be: TLG→A1→A2→A7→A8→A3→A4→A5→A6→TLC; and the third connection manner may be: TLG→A1→A2→A3→A4→A7→A8→A5→A6→TLC; and the fourth connection manner may be: TLG→A1→A2→A7→A8→A5→A6→A3→A4→TLC. In embodiments of other TLVR modules, the extension connections portions TLG and TLC may be electrically connected through the substrate.

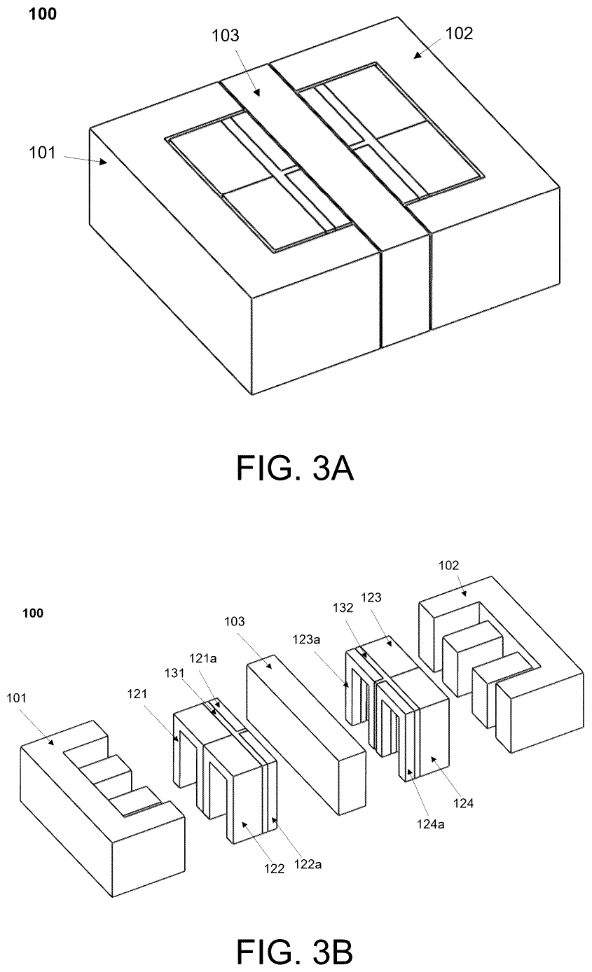

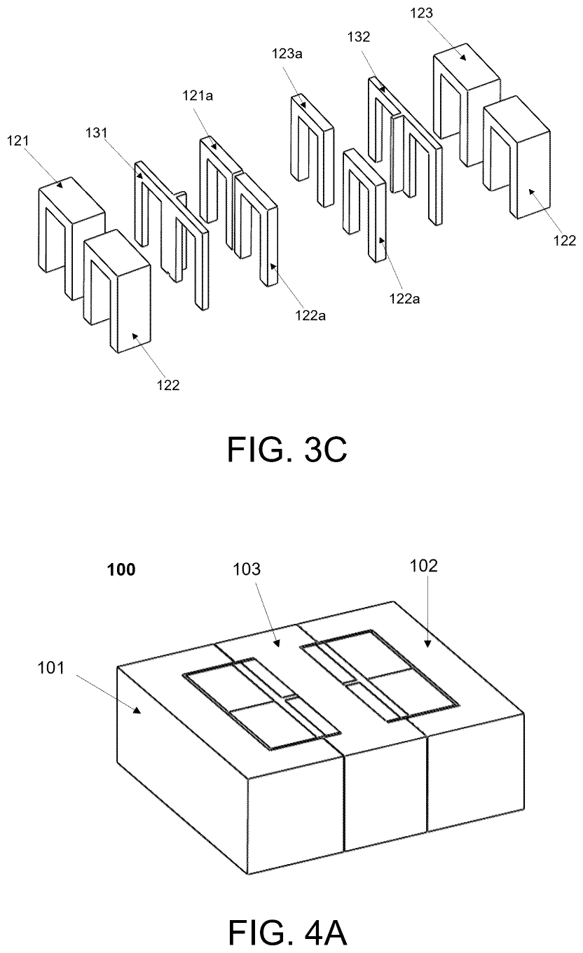

FIG. 3A to FIG. 3C are another embodiment of the integrated inductor 100, FIG. 3B is an exploded schematic diagram of FIG. 3A, and FIG. 3C is an exploded schematic diagram of the winding assembly. The integrated inductor in this embodiment has the same technical effect as the integrated inductor shown in FIG. 2A to FIG. 2D, and the difference between the two is that the assembled magnetic core is adopted in this embodiment. As shown in FIGS. 3A and 3B, the magnetic core 110 comprises a first magnetic core 101, a second magnetic core 102 and a third magnetic core 103; the first magnetic core 101 and the second magnetic core 102 having the same structure, both being comb-shaped; and the third magnetic core 103 being a cuboid. The first winding assembly and the second winding assembly are disposed between the first magnetic core 101 and the third magnetic core 103, and the third winding assembly and the fourth winding assembly are disposed between the second magnetic core 102 and the third magnetic core 103. As shown in FIG. 3C, the winding assembly is assembled together the main winding, the auxiliary winding and the insulating component; the main winding and the auxiliary winding are electrically isolated by means of the insulating component, and the insulating component may be an epoxy resin material or other materials having insulating properties. Or the main winding and the auxiliary winding are molded into one winding assembly by means of a plastic packaging process, such that a plastic packaging material is filled between the main winding and the auxiliary winding to achieve the insulation requirements between the main winding and the auxiliary winding; the plastic packaging material herein may be an epoxy resin material, or may be other materials having insulation properties. Embodiments of the winding assembly may simplify the assembly process.

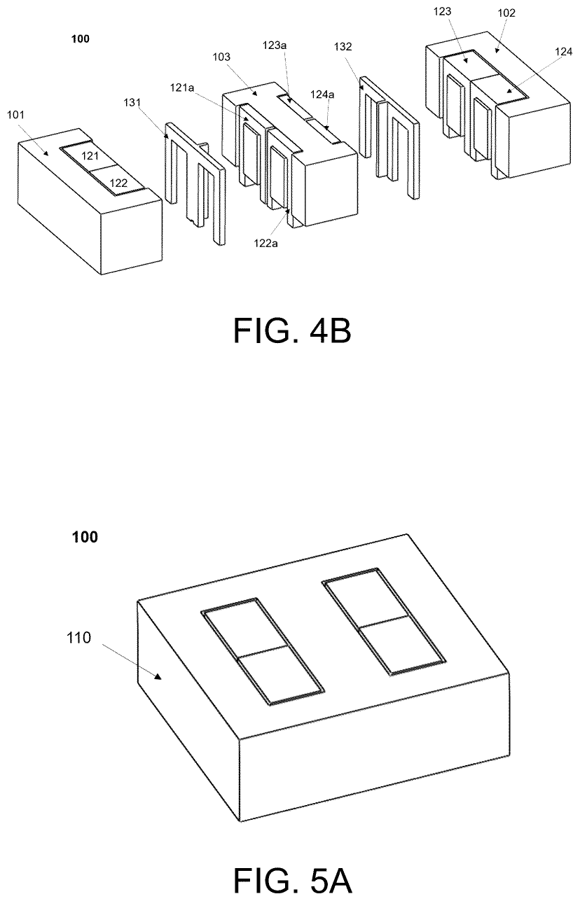

FIG. 4A is another embodiment of the integrated inductor 100 in FIG. 2A, and FIG. 4B is an exploded schematic view of FIG. 4A. As shown in FIG. 4A and FIG. 4B, the integrated inductor in this embodiment has the same technical effect as the integrated inductor shown in FIG. 2A to FIG. 2D. In the present embodiment, the first magnetic core 101, the first main winding 121 and the second main winding 122 are integrally pressed together; the second magnetic core 102, the third main winding 123 and the fourth main winding 124 are integrally pressed together; the third magnetic core 103, the first auxiliary winding 121a, the second auxiliary winding 122a, the third auxiliary winding 123a, and the fourth auxiliary winding 124a are integrally pressed together; and then the three pressing bodies are assembled together by means of the first insulating component 131 and the second insulating component 132. In the present embodiment, after the magnetic core and the winding are integrally pressed, there is a high-temperature annealing process, so that the magnetic property of the magnetic core is improved; and because the number of assembled components is reduced, the difficulty of assembly is reduced.

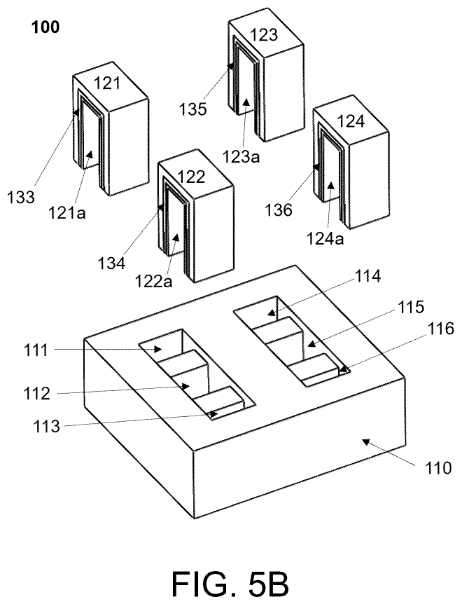

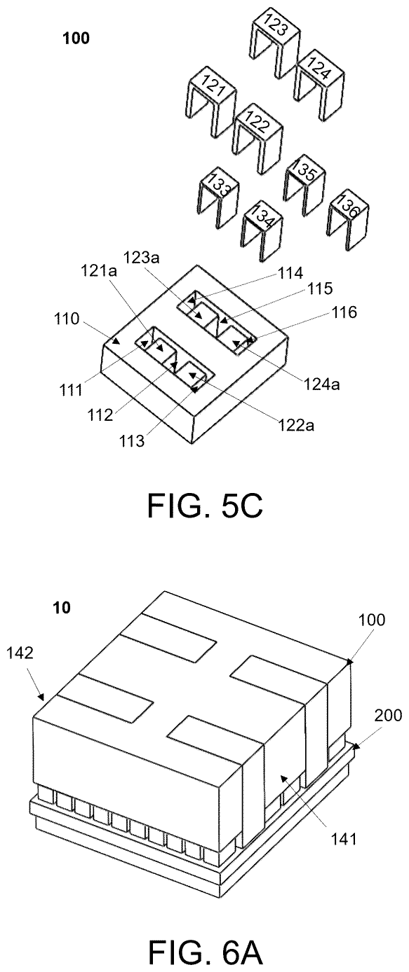

FIG. 5A is another embodiment of the integrated inductor in FIG. 2A, and FIG. 5B is an exploded view of FIG. 5A. Meanwhile, referring to FIG. 5A and FIG. 5B, the integrated inductor in this embodiment has the same technical effect as the integrated inductor shown in FIG. 2A to FIG. 2D. The difference in the present embodiment is that the structure and form of the winding assembly are different. In the embodiment shown in FIG. 2A, the main winding and the auxiliary winding in each winding assembly are horizontally arranged, and the side surface of the main winding and the side surface of the auxiliary winding are combined together by means of an insulating component. In the present embodiment, the main winding and the auxiliary winding in each winding assembly are also “Π” shaped, the main winding and the auxiliary winding are vertically stacked, and the inner surface of the main winding and the outer surface of the auxiliary winding are combined together by means of an insulating component, and then arranged in a corresponding window. In the first winding assembly, the first main winding 121, the insulating component 133 and the first auxiliary winding 121a are vertically stacked in sequence, and are then arranged in the windows 111 and 112 of the magnetic core; in the second winding assembly, the second main winding 122, the insulating component 134 and the second auxiliary winding 122a are vertically stacked, and are then arranged in windows 113 and 112 of the magnetic core; in the third winding assembly, the third main winding 123, the insulating component 135 and the second auxiliary winding 123a are vertically stacked in sequence and then arranged in the windows 114 and 115 of the magnetic core; in the fourth winding assembly, the fourth main winding 124, the insulating component 136 and the second auxiliary winding 124a are vertically stacked in sequence and then arranged in the windows 116 and 115 of the magnetic core. The winding assembly having a vertical structure has stronger coupling characteristics between the main winding and the auxiliary winding, and further reduces the dynamic inductance of the TLVR module.

FIG. 5C is another embodiment of FIG. 4B, after the first auxiliary winding 121a, the second auxiliary winding 122a, the third auxiliary winding 123a, the fourth auxiliary winding 124a and the magnetic core 110 are integrally pressed; a high-temperature annealing treatment is performed, then the insulating component 133, 134, 135 and 136 are assembled in the window of the magnetic core; and then the first main winding 121, the second main winding 122, the third main winding 123 and the fourth main winding 124 are respectively assembled on the insulating component. Preferably, the main winding is a copper flat wire with a insulating layer; in this way, the characteristics of the magnetic core can be further leveraged, and the assembly becomes simpler.

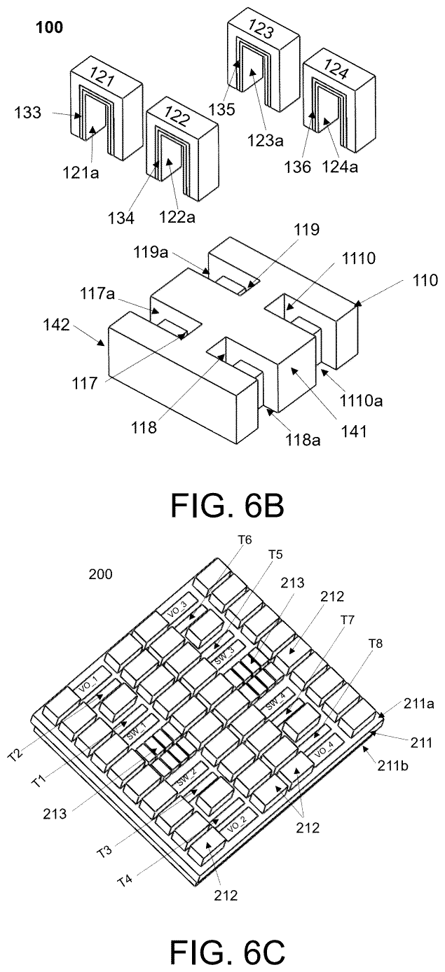

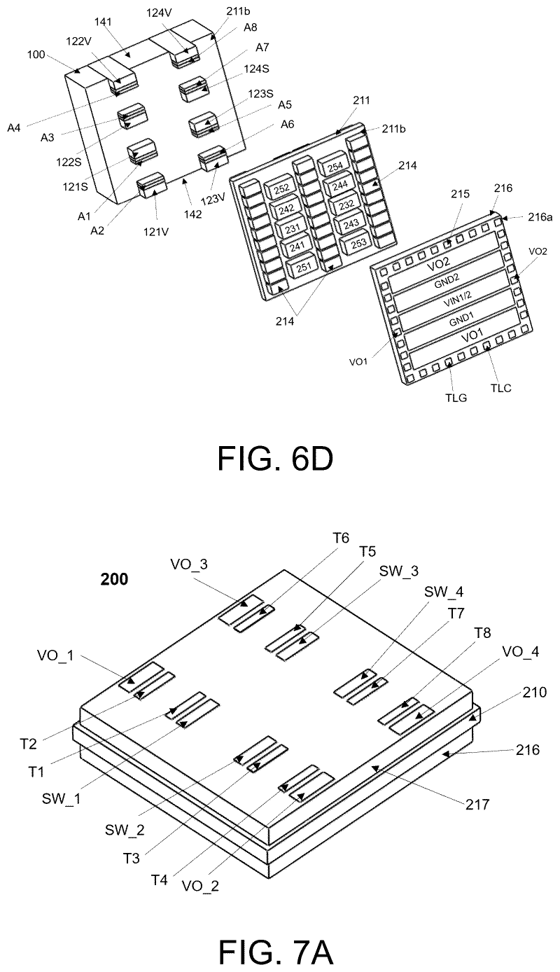

FIG. 6A to FIG. 6D are another embodiment of the TLVR module shown in FIG. 1, FIG. 6A is a three-dimensional structure diagram of a TLVR module, and FIG. 6B is an exploded schematic diagram of the integrated inductor 100. The integrated inductor 100 comprises a magnetic core 110, a first main winding 121, a first auxiliary winding 121a, a second main winding 122, a second auxiliary winding 122a, a third main winding 123, a third auxiliary winding 123a, a fourth main winding 124, a fourth auxiliary winding 124a and an insulating component 133, 134, 135 and 136. The magnetic core 110 comprising four windows 117, 118, 119 and 1110 and four hole grooves 117a, 118a, 119a and 1110a, and a first side surface 141 and a second side surface 142 opposite to each other. The shape and structure of each winding assembly are the same as that shown in FIG. 5B, which will not be repeated here. The vertical portions of the first winding assembly are respectively arranged in the window 117 and the hole groove 117a; and the vertical portion provided in the hole groove 117a is exposed on the second side surface 142 of the magnetic core. The vertical portions of the second winding assembly are respectively arranged in the window 118 and the hole groove 118a; and the vertical portion provided in the hole groove 118a is exposed from the first side surface 141 of the magnetic core. The vertical portions of the third winding assembly are respectively arranged in the window 119 and the hole groove 119a; and the vertical portion provided in the hole groove 119a is exposed on the second side surface 142 of the magnetic core. The vertical portions of the fourth winding assembly are respectively arranged in the window 1110 and the hole groove 1110a; the vertical part provided in the hole groove 1110a is exposed from the first side surface 141 of the magnetic core. In the present embodiment, there is no common magnetic core window between any two winding assemblies, so that electrical isolation between the auxiliary windings is easily achieved; and part of the windings are exposed on the side surface of the magnetic core, so that the size of the magnetic assembly can be further reduced, thereby reducing the size of the TLVR module.

FIG. 6C is a schematic structural diagram of the bottom assembly 200 in FIG. 6A, and FIG. 6D is an exploded schematic diagram of FIG. 6A. Referring to FIG. 6C and FIG. 6D, the pin arrangement of each winding assembly is different from the pin arrangement in FIG. 2D, and taking the first winding assembly as an example, the pins are arranged in the same direction according to the order of 121S, A1, A2, and 121V; the other winding assemblies are also arranged in the same order; and the pin 122S of the second winding assembly is arranged adjacent to the pin 121S of the first winding assembly, and the pin 123S of the third winding assembly is arranged adjacent to the pin 124S of the fourth winding assembly. Correspondingly, pins 121V, 122V, 123V and 124V are all adjacent to the first side surface 141 and the second side surface 142 of the magnetic core. The bottom assembly 200 comprises a substrate 211; the substrate 211 comprises an upper surface 211a and a lower surface 211b opposite to each other. The pads provided on the upper surface 211a of the substrate are also correspondingly arranged according to the order of SW_1, T1, T2, VO_1; the arrangement method of the pins only needs to correspond one-to-one with the pin arrangement of the winding assembly, just the same as the arrangement method of the pins in FIG. 2D.

The output capacitor 214 and the metal columns 231-234, 241-244, 251-252 are disposed on the lower surface 211b of the substrate, and the encapsulant encapsulates the lower surface 211b, the output capacitor and the metal column. Further, the outer surface 216a of the plastic package 216 is provided with pins by means of metallization, and the pins may be input positive connection portions VIN1 and VIN2, ground connection portions GND1 and GND2, output positive connection portions VO1 and VO2, signal connection portions (not shown), and extension connection portions TLG and TLC (not shown). The forming methods of the connecting portions may also refer to the embodiment shown in FIG. 2D, and have the same technical features and technical effects, and details are not described herein again. The arrangement of the connection portions is also correspondingly adjusted according to the pins of the metal columns or the winding assembly. In the present embodiment, these connection portions are arranged in the same direction as the order of VO2, GND2, VIN1, VIN2, GND1, and VO1. Other technical features and technical effects of the present embodiment can refer to the embodiments shown in FIG. 2A to FIG. 2D.

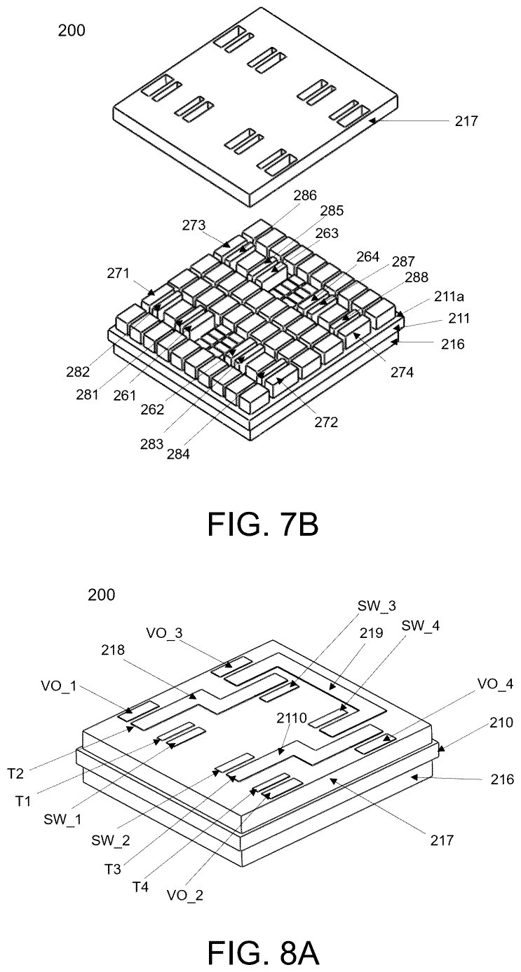

FIG. 7A is another embodiment of the bottom assembly 200, FIG. 7B is an exploded schematic view of FIG. 7A, and with reference to FIGS. 7A and 7B, the embodiment of FIG. 7A has the same technical features and technical effects as the embodiment shown in FIG. 6A. The embodiment shown in FIG. 7A differs from FIG. 6A in that metal columns 261-264, metal columns 271-274, metal columns 281-288 and a plastic package 217 are added on the upper surface 211a of the substrate 211. The plastic package 217 encapsulates the input capacitance and the metal columns of the upper surface 211a of the substrate together, and the pads by metallization are provided on the top surface of the plastic package 217. The metal columns 261 to 264 are respectively electrically connected to the pins 121S, 122S, 123S and 124S by means of corresponding pads SW_1, SW_2, SW_3 and SW_4; the metal columns 271 to 274 are electrically connected to the pins 121V, 122V, 123V and 124V respectively by means of corresponding pads VO_1, VO_2, VO_3 and VO_4. The arrangement of the lower surface 211b of the substrate is the same as the embodiment shown in FIG. 6D. Therefore, when the integrated inductor 100 shown in FIG. 6A is assembled with the double-sided plastic-packaged bottom assembly 200 shown in FIG. 7A, the pin of the integrated inductor is flush with the lower surface of the magnetic core 110, or protrudes from the lower surface of the magnetic core 110 by at least 0.2 mm, and here, the pin of the integrated inductor protruding from the lower surface of the magnetic core by 50 μm is optimal. Other features and effects of the bottom assembly in this embodiment can be referred to the foregoing embodiments.

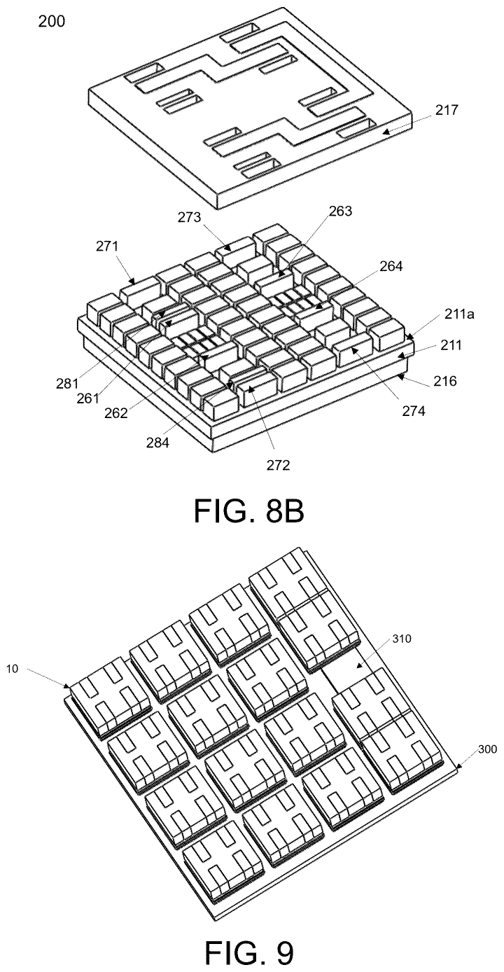

FIG. 8A is another embodiment of the bottom assembly 200, and FIG. 8B is an exploded schematic view of FIG. 8A. The embodiment of FIG. 8A has the same technical features and technical effects as the embodiment shown in FIG. 7A, with the difference being that metal columns 282, 283, 285, 286, 287, and 288 on the upper surface 211a of the substrate are removed, and metallized wires 218, 219, and 2110 are added to the top surface of the plastic package 217; the metallized wires electrically connect the auxiliary windings in series; i.e. the extension connection portion TLG of the TLVR is electrically connected to the pin A1 of the first auxiliary winding by means of the metal column 281 and the pad T1; the pin A2 of the first auxiliary winding is electrically connected to the pin A5 of the third auxiliary winding by means of the wire 218; the pin A6 of the third auxiliary winding is electrically connected to the pin A7 of the fourth auxiliary winding by means of the wire 219; the pin A8 of the fourth auxiliary winding is electrically connected to the pin A3 of the second auxiliary winding by means of the wire 2110; and the pin A4 of the second auxiliary winding is electrically connected to the pin TLC by means of the metal column 284. That is, the electrical connection of the TLVR auxiliary winding is realized on the top surface of the plastic package by means of the top surface wiring of the plastic package 217. The advantage of such an arrangement is that the number of metal columns is reduced, the space occupied by the metal columns on the upper surface 211a of the substrate is saved, more output capacitors can be provided, so as to improve the dynamic performance of the output voltage; meanwhile, the wiring space on the substrate 211 is saved, the efficiency of the TLVR module is improved, and the anti-interference capability of the TLVR module is also improved. The wiring in this embodiment is only one implementation form, and the TLVR connection mode listed in all the above embodiments can be achieved in electrically connected method on the top surface of the plastic package through metallization wires.

Furthermore, an embodiment of an application TLVR module is also disclosed, as shown in FIG. 9. The M four-phase TLVR modules are arranged in a matrix on the adapter substrate 300, usually the TLVR modules are arranged on the back surface of the XPU, thereby implementing a 4*M phase TLVR module combination, and M in the 4*M phase TLVR module combination may be any natural number greater than 0, so as to adapt to requirements of different applications. In other embodiments, the adapter substrate 300 may also be a client system board. The metal columns are optimal by using copper columns, but are not limited thereto, and the metal having good conductive characteristics can all be used. There is a controller arranged on the upper surface of the adapter substrate together with M 4-phase TLVR modules which are uniformly distributed.

The switching device disclosed by the application can be used for realizing the functions of the switch disclosed by the application, such as a Si MOSFET,SiC MOSFET,GaN MOSFET or IGBT MOSFET.

The power supply module according to the embodiment can be an independent module or a part of the power supply module, and can meet the technical features and advantages disclosed by the application.

The “equal” or “same” or “equal to” disclosed by the application needs to consider the parameter distribution of engineering, and the error distribution is within +/−30%; and the included angle between the two line segments or the two straight lines is less than or equal to 45 degrees; the included angle between the two line segments or the two straight lines is within the range of [60, 120]; and the definition of the phase error phase also needs to consider the parameter distribution of the engineering, and the error distribution of the phase error degree is within +/−30%.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

What is claimed is:

1. An N-phase TLVR integrated inductor, comprising a magnetic core and N winding assemblies, wherein N is an even number greater than or equal to 4; the magnetic core comprises an upper surface, a lower surface, a first side surface, a second side surface, a third side surface and a fourth side surface; the magnetic core is provided with at least N windows, and the window penetrates through the upper surface and the lower surface of the magnetic core;
the winding assembly comprises a main winding, an auxiliary winding and an insulating component, wherein the insulating component is arranged between the main winding and the auxiliary winding; the main winding and the auxiliary winding are coupled; the winding assembly is at least partially arranged in the window; and pins are formed on a part of the surface of the main winding and the auxiliary winding exposed on the lower surface of the magnetic core.

2. The N-phase TLVR integrated inductor of claim 1, wherein the main winding, the auxiliary winding, and the insulating component are horizontally arranged or vertically stacked.

3. The N-phase TLVR integrated inductor of claim 1, wherein at least a part of the main winding is exposed on the upper surface of the magnetic core.

4. The N-phase TLVR integrated inductor of claim 1, wherein a part of the winding assembly is exposed on a side surface of the magnetic core.

5. The N-phase TLVR integrated inductor of claim 2, wherein the shape of the main winding is the same as the shape of the auxiliary winding.

6. The N-phase TLVR integrated inductor of claim 5, wherein the shape of the main winding and the auxiliary winding is in “Π” shape, and comprises a horizontal portion and two vertical portions; the two vertical portions are disposed in two windows respectively; the upper surface of the horizontal portion is flush with the upper surface of the magneticcore; the lower surface of the two vertical portions is formed to pin protrusions.

7. The N-phase TLVR integrated inductor of claim 6, wherein the two winding assembly protrude three windows; two adjacent vertical portions of the two winding assemblies share one window; each of two non-adjacent vertical portions of the two winding assemblies protrudes one windows respectively.

8. The N-phase TLVR integrated inductor of claim 5, wherein the magnetic core comprises at least N hole grooves.

9. The N-phase TLVR integrated inductor of claim 8, wherein the shape of the main winding and the auxiliary winding is in “Π” shape, and comprises a horizontal portion and two vertical portions; the two vertical portions are disposed in one window and one hole groove respectively;
the upper surface of the horizontal portion is flush with the upper surface of the magnetic core; the lower surface of the two vertical portions is formed to pin protrusions.

10. The N-phase TLVR integrated inductor of claim 9, wherein a part of the vertical portion of each winding assembly disposed in the hole groove is exposed on the side surface of the magnetic core.

11. The N-phase TLVR integrated inductor of claim 5, wherein the main windings and the auxiliary windings of two winding assemblies share one insulating component; the two main windings are arranged at one side of the insulating component, and the two auxiliary windings are arranged at the other side of the insulating component.

12. The N-phase TLVR integrated inductor of claim 2, wherein the winding assembly is integrally formed by a plastic packaging process; or the main winding, the auxiliary winding and the insulating component in each winding assembly are assembled together.

13. The N-phase TLVR integrated inductor of claim 1, wherein the winding assembly protrudes from the lower surface of the magnetic core to form a pin protrusion, and a height of the pin protrusion is greater than or equal to 0.7 mm.

14. The N-phase TLVR integrated inductor of claim 1, wherein a height between the pin and the lower surface of the magnetic core is between 0 and 0.2 mm.

15. The N-phase TLVR integrated inductor of claim 1, wherein the magnetic core comprises a first magnetic core, a second magnetic core and a third magnetic core; the third magnetic core is arranged between the first magnetic core and the second magnetic core; the winding assemblies are arranged between the first magnetic core and the third magnetic core, and between the second magnetic core and the third magnetic core.

16. The N-phase TLVR integrated inductor of claim 15, the first magnetic core and part of the main windings are integrally pressed to form a first magnetic assembly; the second magnetic core and the other part of the main windings are integrally pressed to form a second magnetic assembly; the third magnetic core and the auxiliary winding are integrally pressed to form a third magnetic assembly; the first magnetic assembly, the second magnetic assembly and the third magnetic assembly are assembled by means of the insulating component.

17. An N-phase TLVR module, comprising an N-phase TLVR integrated inductor of claim 1 and a bottom assembly; the bottom assembly comprises a substrate and a switching device; the bottom assembly comprises an upper surface and a lower surface opposite to each other; the N-phase TLVR module is arranged on the upper surface of the bottom assembly; one pin of each main winding is electronically connected with the switching device; a output positive connection portion is disposed on the lower surface of the substrate; the other pin of each main winding is electronically connected with the output positive connection portion.

18. The N-phase TLVR module of claim 17, wherein the bottom assembly further comprises a capacitor and a metal column; the substrate comprises an upper surface and a lower surface opposite to each other; the capacitor is arranged on the substrate; the switching device is embedded in the substrate; one pin of each main winding is electrically connected to the switching device by means of the substrate, and the other pin of each main winding is electrically connected to the capacitor by means of the substrate; and the metal columns are provided on the upper surface and/or the lower surface of the substrate.

19. The N-phase TLVR module of claim 18, wherein a SW pad and an output positive pad are disposed on the upper surface of the bottom assembly; an input positive connection portion and a ground connection portion are disposed on the lower surface of the bottom assembly; one pin of each main winding is fixed and electronically connected with the SW pad, the other pin of each main winding is fixed and electronically connected with the output positive pad; the switching device is a vertical device; the switching device comprises a first switching device and a second switching device; a drain electrode of the first switching device and a source electrode of the second switching device face the lower surface of the substrate, the drain electrode of the first switching device is electronically connected with the input positive connection portion, the source electrode of the second switching device is electronically connected with the ground connection portion; a source electrode of the first switching device and a drain electrode of the second switching device face the upper surface of the substrate, and are both electronically connected to the SW pad; the output positive pad and the output positive connection portion are electrically connected.

20. The N-phase TLVR module of claim 19, wherein the drain electrode of the first switching device is electronically connected to the input positive connection portion by means of the metal column; the source electrode of the second switching device is electronically connected to the ground connection portion by means of the metal column; the source electrode of the first switching device and the drain electrode of the second switching device are electronically connected by means of the metal column or a redistribution layer.

21. The N-phase TLVR module of claim 18, wherein the capacitor comprises an input capacitor and/or an output capacitor; the input capacitor is disposed on the upper surface of the substrate, and two ends of the input capacitor are electronically connected to the input positive connection portion and the ground connection portion respectively; the output capacitor is disposed on the lower surface of the substrate, and two ends of the output capacitor are electronically connected to the output positive connection portion and the ground connection portion respectively.

22. The N-phase TLVR module of claim 18, wherein the pin is flush with the lower surface of the magnetic core, and the winding assembly and the substrate are electrically connected through the metal column.

23. The N-phase TLVR module of claim 18, wherein a part of the metal columns are used for electrically connecting the auxiliary winding and the substrate, and are used for realizing the electrical connection of the auxiliary winding loop.

24. The N-phase TLVR module of claim 18, wherein the upper surface of the substrate and the metal column and the capacitor disposed on the upper surface are molded together to form an upper surface plastic package, and the upper surface of the upper surface plastic package is provided with a pad.

25. The N-phase TLVR module of claim 24, wherein a part of the pads is configured to electrically connect the auxiliary winding.

26. The N-phase TLVR module of claim 18, wherein the lower surface of the substrate and the metal column and the capacitor disposed on the lower surface are molded together to form a lower surface plastic package, and the lower surface of the lower surface plastic package is provided with the connection portions.

27. The N-phase TLVR module of claim 17, wherein the auxiliary winding is electrically connected through the substrate; auxiliary winding pads are disposed on the upper surface of the bottom assembly, the auxiliary winding pads are fixed with and electronically connected to two ends of the auxiliary winding; a extension connection portion is disposed on the lower surface of the bottom assembly, and the extension connection portion is used for electronically connecting the auxiliary winding between at least two N-phase TLVR modules.

28. An XPU vertical power supply system includes an adapter substrate, a controller, and M N-phase TLVR modules of claim 17; the adapter substrate includes an upper surface and a lower surface opposite to each other, the M N-phase TLVR modules are disposed on the upper surface of the adapter substrate, and the lower surface of the adapter substrate is configured to electrically connect to an external assembly.

29. The XPU vertical power supply system of claim 28, wherein the M N-phase TLVR modules and the controller are uniformly distributed on the upper surface of the adapter substrate.
